(19) United States
(12) Patent Application Publication
(10) Pub. No.: US 2003/0212897 A1
(43) Pub. Date: Nov. 13, 2003

(54) Method and system for maintaining secure semiconductor device areas

(76) Inventors: Russell Dickerson, Redondo Beach, CA (US); Antonio Guillermo, Torrance, CA (US)

Correspondence Address: Ted R. Rittmaster, Foley & Lardner, Suite 3500, 2029 Century Park East, Los Angeles, CA, 90067-3021, US

(21) Appl. No.: 09/932,408

(22) Filed: Aug. 18, 2001

(51) Int. Cl. H04L 9/00; G06F 9/455

(52) U.S. Cl. 713/200; 703/28

(57) ABSTRACT

A method and system for preventing access to secure areas of semiconductor devices using a control signal in conjunction with a secure area access obstruction circuit. A semiconductor device may have a user mode and a supervisor mode. When entering a supervisor mode, a control signal may transition from one logic state to another. Embodiments of the present invention utilize the control signal in conjunction with the secure area access obstruction circuit to prevent access to secure areas of the semiconductor device.

### BACKGROUND

1. Field of the Invention

The present invention relates to the field of semiconductor devices, and more particularly to obstructing unauthorized access to secure areas of semiconductor devices.

2. Description of Related Art

The transfer of sensitive data over public and private networks continues to proliferate at a rapid pace. Credit card numbers, social security numbers, account passwords, classified information and other sensitive data are routinely transferred over networks countless times every day. Commensurate with the transfer of sensitive data is the requirement that such data be transferred securely, thereby ensuring that the sensitive nature of the data is not compromised. Thus, the marketplace has seen the development of semiconductor devices that implement data encryption functions to effect the secure transfer of sensitive data.

Semiconductor devices implementing data encryption functions may utilize two modes: a user mode and a supervisor mode (the supervisor mode may also be called, for example, secure mode or superuser mode). User mode typically permits a user of the semiconductor device to program the semiconductor device for a particular application and utilize the functions of the device. However, user mode ideally prevents access to secure internal memory and registers. While user mode may allow a user to utilize functions of a data encryption semiconductor device, ideally, the specific code, memory and register contents detailing the manner in which such functions have been implemented generally would remain unavailable to the user. Thus, user mode simply allows a user to customize a semiconductor device to a particular application.

Supervisor mode, on the other hand, may allow unrestricted access to code, internal and external memory and registers. Thus, in supervisor mode, the specific code and register contents detailing the manner in which data encryption functions have been implemented are observable. Because of this, user mode has only limited access to such functions and executes only a limited number of commands that run in supervisor mode.

The development of firmware for semiconductor devices, such as, for example, a microprocessor and its associated assembly code that implements cryptographic algorithms, or, for example, an application specific integrated circuit (ASIC) embodying a microprocessor, memory and data encryption circuitry, has traditionally been facilitated by an in-circuit emulator (ICE). Those of ordinary skill in the art will understand that an ICE allows a developer to write and debug code, to set breakpoints and to observe registers, internal memory and program flow on the fly without the need to commit code to ROM. An ICE may interface with a test port designed into the integrated circuit.

The facilitation of firmware development for integrated circuits using an ICE, however, has traditionally had drawbacks. Because using an ICE allows a user to observe registers, internal memory and program flow while in supervisor mode, any user utilizing an ICE in conjunction with a semiconductor device for application development may also obtain access to memory, registers and code that should normally be unavailable to an ordinary user. Consequently, data encryption functions and sensitive data may be observable, and data and system security may be compromised. Therefore, the availability of an ICE has traditionally rendered supervisor modes essentially useless.

Accordingly, the data encryption industry needs semiconductor devices with ICE interfaces that allow users of such semiconductor devices to develop and debug custom applications for such devices, while at the same time obstructing these users from gaining access to proprietary and confidential memory, registers and code.

### SUMMARY OF THE DISCLOSURE

Embodiments of the present invention relate to methods and systems for obstructing access to a secure area of a semiconductor device. A control signal may be provided indicating that the semiconductor device has entered a secure mode. The control signal may be used to obstruct access to the secure area. The control signal may be used by gating another signal with the control signal or by using the control signal to select a multiplexer channel. The control signal may also be used to enable another circuit.

The control signal may be provided by decoding a plurality of signals. The plurality of signals may originate from a microprocessor core. When the semiconductor device enters the secure mode, the control signal may transition from a first logic state to a second logic state. The first logic state may be a high logic state and the second logic state may be a low logic state. Alternatively, the first logic state may be a low logic state and the second logic state may be a high logic state.

The semiconductor device may also interface to an in-circuit emulator. At some point while the semiconductor device is interfaced to the in-circuit emulator, the semiconductor device enters the secure mode in response to a command from the in-circuit emulator. The command may be a software interrupt.

The semiconductor device and the secure area may be used in connection with data encryption and may include a control signal for indicating a mode of the semiconductor device; a microprocessor core for generating the control signal; and a circuit for obstructing access to the secure area connected to the control signal. The control signal may be used by the circuit for obstructing access to the secure area when the mode indicated by the control signal is a secure mode.

The circuit for obstructing access to the secure area may be a logic gate, such as, for example, an AND gate. The circuit for obstructing access to the secure area may also be a multiplexer. The semiconductor device may also comprise a port for an in-circuit emulator. Furthermore, the semiconductor device may use memory within the secure area and may be implemented as an application specific integrated circuit.

These and other objects, features, and advantages of embodiments of the invention will be apparent to those skilled in the art from the following detailed description of embodiments of the invention when read with the drawings and appended claims.

### BRIEF DESCRIPTION OF THE DRAWINGS

FIG. 1A is a block diagram of a conventional system in the art attached to an in-circuit emulator.

FIG. 1B is a block diagram of a conventional system in the art attached to an in-circuit emulator.

FIG. 2 is a block diagram of a semiconductor device implementing a Joint Test Action Group (JTAG) port.

FIG. 3A is a block diagram of a typical semiconductor device common in the art including a microprocessor core and other circuitry.

FIG. 3B is a logic state diagram showing transition from a user mode to a supervisor mode.

FIG. 4 is a block diagram of an embodiment of the present invention having a secure area access obstruction circuit.

FIG. 5A is an embodiment of the present invention showing an AND gate as a secure area access obstruction circuit.

FIG. 5B is a truth table for the embodiment of the present invention shown in FIG. 5A.

FIG. 6A is an embodiment of the present invention showing a multiplexer as a secure area access obstruction circuit.

FIG. 6B is a truth table for the embodiment of the present invention shown in FIG. 6A.

### DETAILED DESCRIPTION

In the following description of preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the preferred embodiments of the present invention.

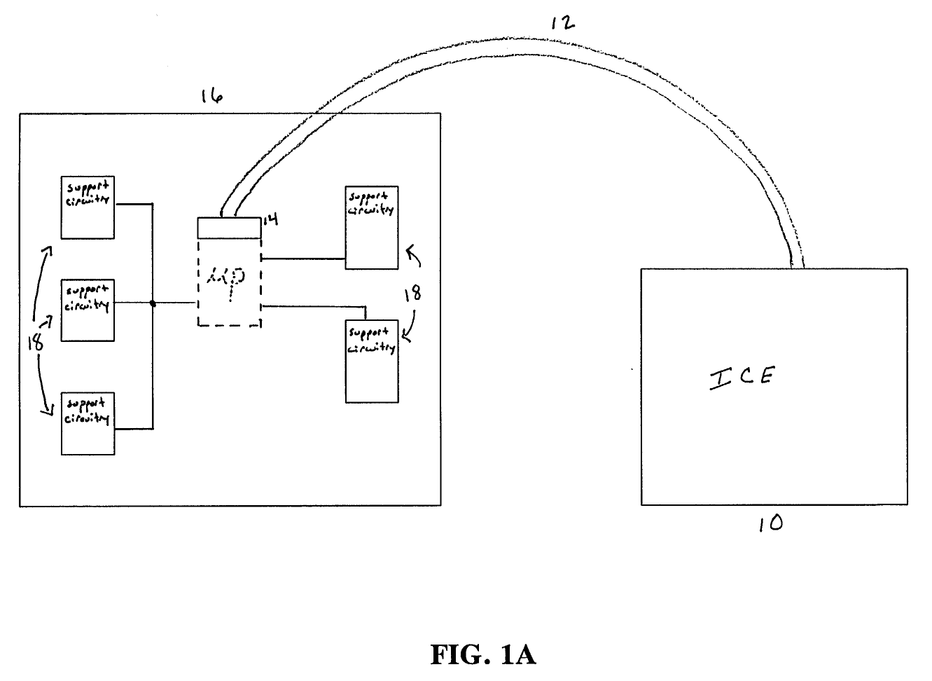

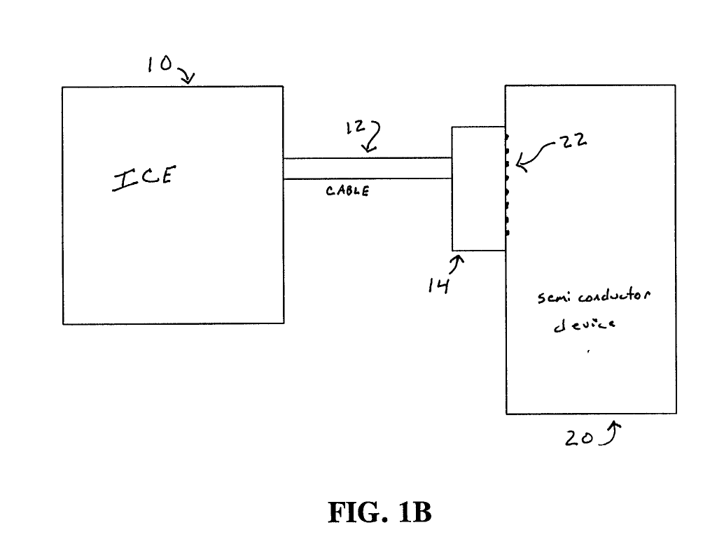

A generalized system for firmware test and development using an in-circuit emulator (ICE) is shown in FIG. 1A. An ICE 10, which may be implemented using, for example, a personal computer, incorporates a cable 12 terminated by a connector 14. The connector 14 interfaces to an electronic system 16 by plugging into an area of the system 16 normally occupied by a microprocessor or microcontroller. In this configuration, the ICE may be substituted for a microprocessor, interfacing with memory, glue logic and other support circuitry 18 in the same way a microprocessor would if a microprocessor were soldered into the system 16. Thus, a user may program and operate the ICE 10 and cause it to function as the system 16 microprocessor. A user may also make changes to the microprocessor code, or firmware, running on the ICE 10 without having to reprogram the microprocessor or its associated ROM every time a change is made. This is particularly expedient when developing microprocessor or microcontroller code or firmware.

Another system for firmware test and development using an ICE is shown in FIG. 1B. As before, an ICE 10 incorporates a cable 12 terminated by a connector 14. However, rather than plugging into a portion of a system normally occupied by a microprocessor or microcontroller, as shown in the system of FIG. 1A, the connector 14 interfaces to a semiconductor device 20 through a port 22. In this configuration, the ICE 10 may read and write to the semiconductor device 20 through the port 22. The ICE 10 may observe code, internal memory and registers by reading data out of the port 22.

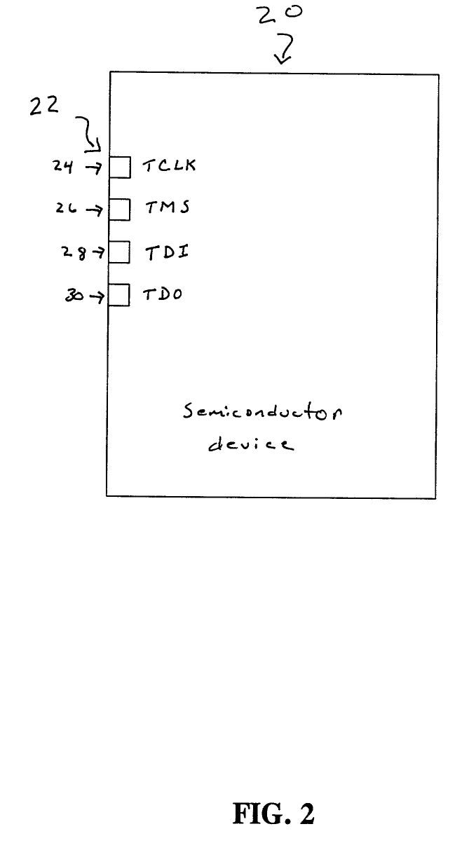

The port 22 shown in FIG. 1B may be implemented in a variety of ways. For example, FIG. 2 shows signals implemented in a Joint Test Action Group (JTAG) port. JTAG is a standardized approach to integrated circuit testing whereby test points and test facilities are built directly into the integrated circuit. The JTAG standard is defined by the Institute of Electrical and Electronics Engineers (IEEE) as standard 1149.1 (i.e., IEEE 1149.1). As shown in FIG. 2, a semiconductor device 20, or integrated circuit, incorporates a JTAG port 22 with signals common to all JTAG ports, including, without limitation, Test Clock (TCLK) 24, Test Mode Select (TMS) 26, Test Data In (TDI) 28 and Test Data Out (TDO) 30. These signals may be used in conjunction with the ICE 10 to facilitate testing and debug of firmware or code. Internal memory and registers may be read through the port 22.

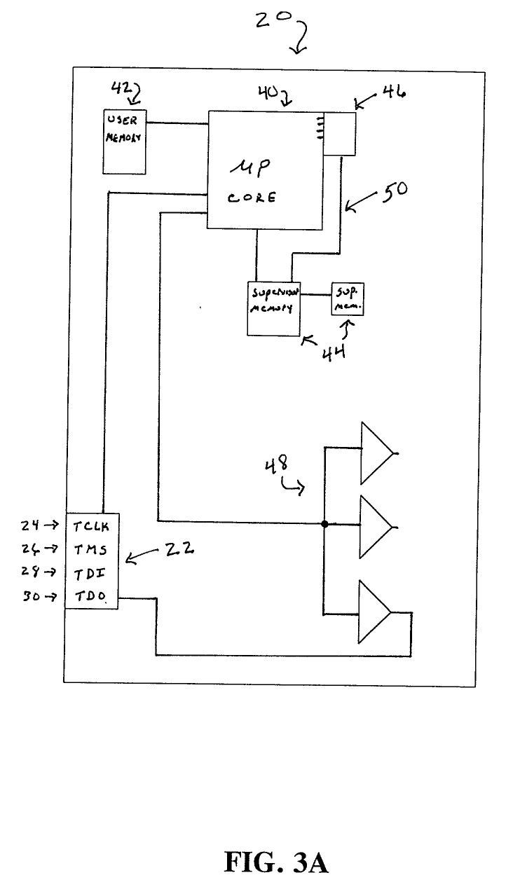

A typical semiconductor device 20 common in the art is shown in FIG. 3A. The semiconductor device 20 may include, for example, a microprocessor core 40, user mode memory 42, supervisor mode memory 44, and support or glue logic 46. The support logic 46 may include a decoder. The semiconductor device 20 may also include a port 22. For example, FIG. 3A shows the semiconductor device 20 with a JTAG port 22 with signals TCLK 24, TMS 26, TDI 28 and TDO 30. The semiconductor device 20 may also include, for example, buffers/drivers 48 for sending output data, such as, for example, TDO 30, out externally. As shown in FIG. 3A, the semiconductor device 20 may be used as a general purpose device for general purpose processing. In an embodiment according to the present invention, the semiconductor device 20 is used to implement data encryption functions and stores sensitive data and code in its secure areas. However, the semiconductor device 20 is not limited to data encryption applications and could be used in any application requiring secure areas for sensitive data and where a supervisor or secure mode is desired.

The semiconductor device 20 may be implemented in a variety of ways. For example, the semiconductor device 20 may be implemented as an application specific integrated circuit (ASIC). Alternatively, the semiconductor device 20 may be implemented in a field programmable gate array (FPGA) or other programmable device. The semiconductor device 20 may also be implemented as a system using discrete components.

The operation of the semiconductor device 20 when changing from a user mode to a supervisor mode according to an embodiment of the present invention may be seen in conjunction with FIGS. 3A and 3B. A user may issue a command, such as a software interrupt (SWI), directing the microprocessor core 40 to change modes, for example, from a user mode to a supervisor mode. Subsequently, support logic 46 may decode any of a variety of signals generated by the microprocessor core 40 in response to the command and toggle a control signal on a control line 50 as shown in FIG. 3B, thereby indicating that a system mode has changed. For example, when the system is in user mode, the control signal may be at a high logic state 52, whereas after the command has been issued directing the system to change to supervisor mode, the control signal may transition to a low logic state 54. Alternatively, the control signal may transition from a low logic state to a high logic state in response to a command directing a mode change. When, for example, the control signal transitions to a low logic state 54 as a result of the semiconductor device entering supervisor mode, the secure areas of the semiconductor device 20, such as, for example, the supervisor mode memory 44, become enabled.

Deficiencies inherent in the prior art may now be seen in conjunction with FIGS. 1B and 3A. If a user connects an ICE 10 to a semiconductor device 20 for testing or developing code for the semiconductor device 20 and enters a user mode, user mode memory 42 and other general purpose registers may be available to the user at port 22. In addition, should a user issue a command, such as a SWI, to direct the microprocessor core 40 to change into a supervisor mode, the secure areas of the semiconductor device 20, for example, supervisor mode memory 44 and secure registers, may also be available to the user at port 22, completely defeating the purpose of a secure mode.

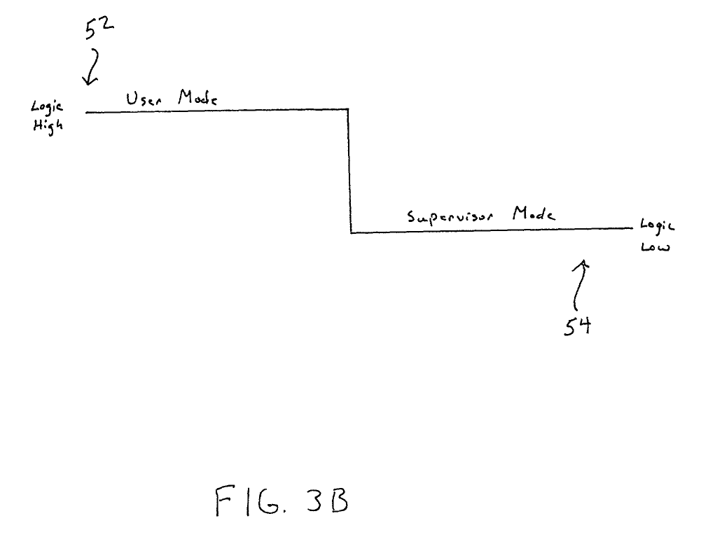

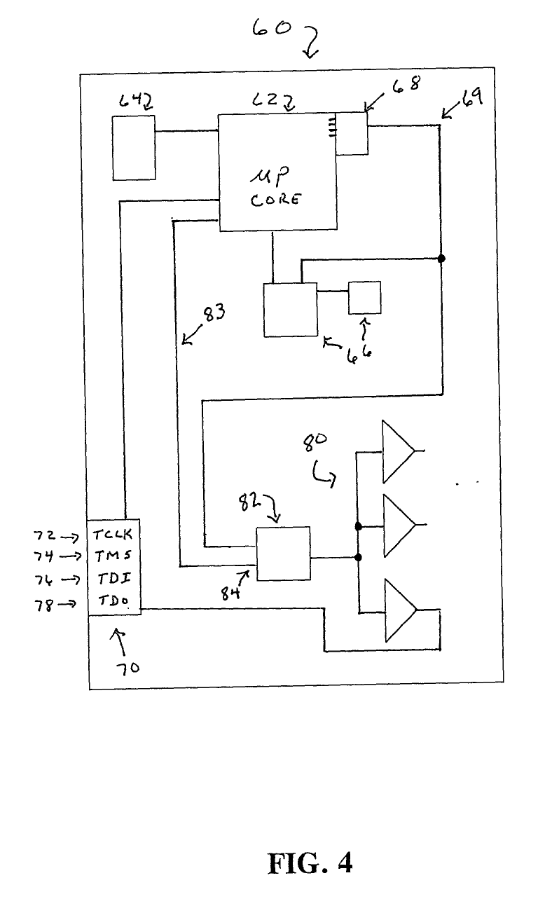

One manner of addressing such deficiencies inherent in the prior art, according to an embodiment of the present invention shown in FIG. 4, includes a semiconductor device 60, which may include, for example, a microprocessor core 62, user mode memory 64, supervisor mode memory 66, and support or glue logic 68. The support logic 68 may include a decoder. The output of the support logic 68 may be a control signal on a control line 69. The semiconductor device 60 may also include a port 70. For example, FIG. 4 shows a semiconductor device 60 as including a JTAG port with signals TCLK 72, TMS 74, TDI 76 and TDO 78. The semiconductor device 60 may also include, for example, buffers/drivers 80. The semiconductor device 60 may also include a secure area access obstruction circuit 82. The secure area access obstruction circuit 82 may be used in conjunction with a control signal on the control line 69 which may be generated by the microprocessor core 62 in conjunction with the support or glue logic 68, which may be a decoder.

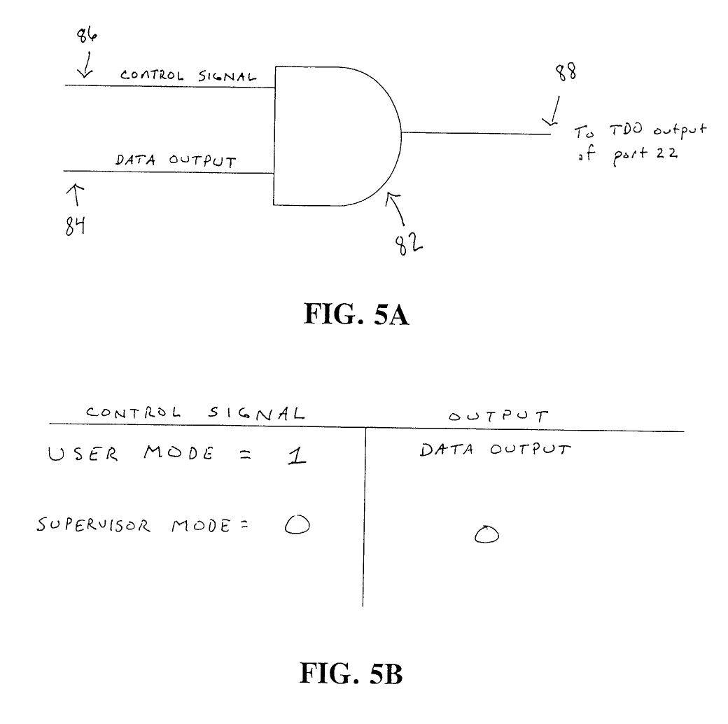

Operation of the semiconductor device 60 implementing the secure area access obstruction circuit 82 may be seen in conjunction with FIGS. 4, 5A and 5B. In FIG. 5A, the secure area access obstruction circuit 82 has been implemented using an AND gate. A data output line 83 connects to a first input 84 of the secure area access obstruction circuit 82. The control line 69 connects to a second input 86 of the secure area access obstruction circuit 82.

Referring to FIGS. 4 and 5B, when a user is developing or debugging code or firmware for the semiconductor device 60 and is in user mode, the microprocessor core 62 may generate any of a number of internal signals that may be decoded or otherwise operated on using the support logic 68. The output of the support logic, i.e., the control signal on the control line 69, may then be in a particular logic state. For example, the control signal on the control line 69 may be in a high logic state. Consequently, the output 88 of the secure area access obstruction circuit 82 will follow the logic state of the data output line 83 according to the truth table shown in FIG. 5B.

Continuing to refer to FIG. 5B, when a user issues a command, thereby directing the microprocessor core 62 to enter a supervisor mode, any of a number of internal signals may be decoded or otherwise operated on using the support logic 68. The output of the support logic, i.e., the control signal on the control line 69, may then transition from, for example, a high logic state to a low logic state. When the control signal on the control line 69 is in a low logic state (i.e., logic “0”), the output 88 of the secure area access obstruction circuit 82 will be low and will remain low until the user returns to user mode and, consequently, the control signal on the control line 69 returns to a high logic state.

Thus, according to an embodiment of the invention as just described, a user who attempts to read secure areas of the semiconductor device 60 by entering a supervisor mode will read nothing but logic “0's.” The user's attempt to compromise the secure areas of the semiconductor device 60 will be obstructed, and the only time a user will be unobstructed in an attempt to obtain meaningful data from the semiconductor device 60 is when the user is in user mode, a mode that does not permit access to secure areas of the semiconductor device 60.

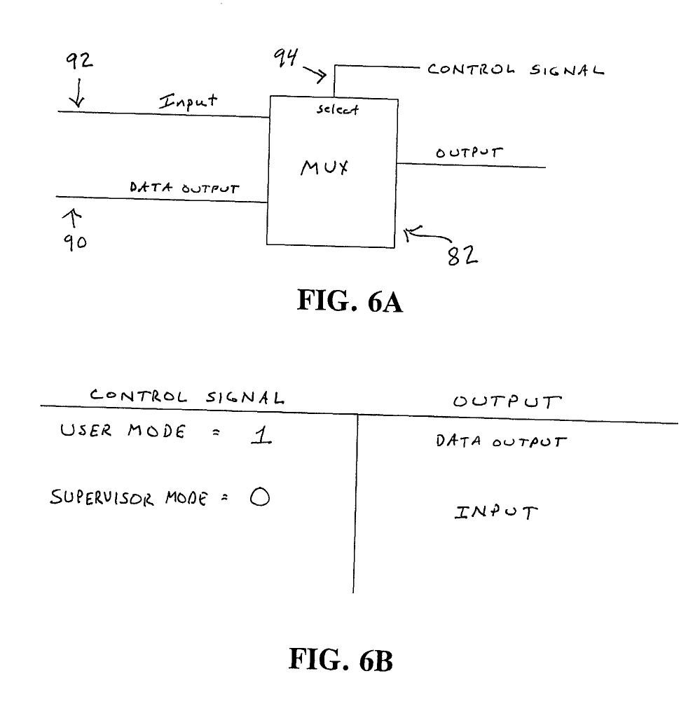

Another embodiment according to the present invention is shown in FIG. 6A. Rather than using an AND gate as the secure area access obstruction circuit 82, a multiplexer is used. Operation of the semiconductor device 60 implementing a multiplexer as the secure area access obstruction circuit 82 may be seen in conjunction with FIGS. 6A and 6B. The data output line 83 connects to a first input 90 of the secure area access obstruction circuit 82. The control signal on the control line 69 connects to a selection terminal 94 of the secure area access obstruction circuit 82. Any of a variety of inputs may connect to a second input 92 of the secure area access obstruction circuit 82. For example, the second input 92 may be hard wired to ground potential. Alternatively, the second input 92 may be connected to the signal TDI 76.

Referring to FIG. 6B, when a user develops or debugs code or firmware for the semiconductor device 60 and is in user mode, the microprocessor core 62 may generate any of a number of internal signals that may be decoded or otherwise operated on using the support logic 68. The output of the support logic, i.e., a control signal on the control line 69, may then be in a particular logic state. For example, a control signal on the control line 69 may be in a high logic state. When the control signal on the control line 69 is in a high logic state, the output 96 of the secure area access obstruction circuit 82 will follow the logic state of the data output 83 according to the truth table shown in FIG. 6B.

Continuing to refer to FIG. 6B, when a user issues a command, thereby directing the microprocessor core 62 to enter a supervisor mode, any of a number of internal signals may be decoded or otherwise operated on using the support logic 68 to cause the control signal 69 to transition from, for example, a high logic state to a low logic state. When the control signal on the control line 69 is in a low logic state (i.e., logic “0”), the output 96 of the secure area access obstruction circuit 82 will follow the input 92 of the secure area access obstruction circuit 82 until the user returns to user mode and, consequently, the control signal on the control line 69 returns to a high logic state. Thus, the output 96 available to the user when in supervisor mode may be a specific signal or bit pattern intended by the semiconductor device 60 developer (not the user). For example, the output 96 may simply be logic “0” if the input 92 is, as stated previously, hard wired to ground potential. Conceivably, the semiconductor device 60 developer could connect any desired signal to the input 92 to be made available to the user when the user attempts to enter a supervisor mode.

For example, the input 92 could be connected to the output of a state machine that produces a particular pattern of 1's and 0's after the control signal 69 transitions to a logic low state. The pattern may be, for example, all 1's or all 0's, alternating 1's and 0's, or any other pattern desired by the semiconductor device 60 developer. The input 92 could also be connected, for example, to the microprocessor core 40 or another, independent microprocessor. The microprocessor core or other microprocessor could be programmed to output a variety of bit patterns after the control signal on the control line 69 transitions to a logic low state.

Embodiments of the present invention are not limited to operation on the data output line 78. Embodiments of the present invention may operate on a variety of signals to effect the desired result of obstructing access to a secure area of a semiconductor device. For example, if a JTAG port is implemented on a semiconductor device, embodiments of the present invention may operate on signals TCLK 72, TMS 74 or TDI 76. Embodiments of the present invention may operate on any signal or signals to effect obstructing access to a secure area of a semiconductor device as long as a response is given to the piece of equipment trying to gain access to such secure area and no confidential, proprietary or otherwise secure data is output by the semiconductor device.

Assume, for example, that a control signal were utilized in conjunction with the secure area access obstruction circuit 82 to operate on signal TCLK 72. If the control signal indicates that the semiconductor device has entered into a supervisor mode and transitions from a high logic state to a low logic state, the control signal may be gated with the signal TCLK 72 such that the signal TCLK 72 is held at a low logic level until the semiconductor device is no longer in a supervisor mode. With TCLK 72 held at a low logic level (i.e., the test clock being held at ground potential), the test circuitry of the semiconductor device would be essentially useless and no useable information could be obtained from any of the secure areas of the semiconductor device.

Moreover, embodiments of the present invention need not require a JTAG port or any other test port to operate effectively. The secure area access obstruction circuit 82 may be utilized in conjunction with a control signal indicating entry into a supervisor mode to operate on any input or output of a semiconductor device that will, in effect, obstruct a user's attempt at accessing secure areas of the semiconductor device.

While particular embodiments of the present invention have been shown and described, it will be obvious to those skilled in the art that the invention is not limited to the particular embodiments shown and described and that changes and modifications may be made without departing from the spirit and scope of the appended claims.

What is claimed is:

1. A method for obstructing access to a secure area of a semiconductor device comprising:
providing a control signal indicating that the semiconductor device has entered a secure mode; and
obstructing access to the secure area utilizing the control signal.

2. The method of claim 1, wherein obstructing access to the secure area comprises gating another signal with the control signal.

3. The method of claim 1, wherein obstructing access to the secure area comprises is selecting a multiplexer channel with the control signal.

4. The method of claim 1, wherein obstructing access to the secure area comprises enabling another circuit with the control signal.

5. The method of claim 1, wherein the secure area is used in connection with data encryption.

6. The method of claim 1, wherein providing a control signal further comprises decoding a plurality of signals to generate the control signal.

7. The method of claim 1, wherein the control signal transitions from a first logic state to a second logic state when the semiconductor device enters the secure mode.

8. The method of claim 7, wherein the first logic state is a logic high and the second logic state is a logic low.

9. The method of claim 7, wherein the first logic state is a logic low and the second logic state is a logic high.

10. The method of claim 1, further comprising:
connecting an in-circuit emulator to the semiconductor device; and
generating a command from the in-circuit emulator to the semiconductor device,
wherein the command requests access to the secure area of the semiconductor.

11. The method of claim 10, wherein the semiconductor device enters the secure mode when the in-circuit emulator is connected to the semiconductor device.

12. The method of claim 10, wherein the command is a software interrupt.

13. A system for obstructing access to a secure area of a semiconductor device comprising:
a first circuit for generating a control signal; and
a second circuit for obstructing access to the secure area connected to the control signal,
wherein the control signal is utilized by the second circuit to obstruct access to the secure area when a mode indicated by the control signal is a secure mode.

14. The system of claim 13, wherein the second circuit is a logic gate.

15. The system of claim 14, wherein the logic gate is an AND gate having a first input connected to the first circuit such that the first input responds to the control signal;
a second input connected to a circuit supplying output data; and
an output connected to a port of the semiconductor device.

16. The system of claim 13, wherein the second circuit is a multiplexer.

17. The system of claim 13, further comprising a port for an in-circuit emulator.

18. The system of claim 17, wherein the semiconductor device enters the secure mode when the in-circuit emulator is connected to the port.

19. The system of claim 13, wherein the secure area comprises memory.

20. The system of claim 13, wherein the semiconductor device is an application specific integrated circuit.

21. The system of claim 20, wherein the first circuit is a microprocessor core.

22. They system of claim 13, wherein the first circuit is a decoder.

23. The system of claim 15, wherein the output is buffered before connecting to the port.

24. A system for obstructing access to a secure area of a semiconductor device comprising:
a microprocessor core;
a decoder connected to an output of the microprocessor core;
a control line connected to an output of the decoder;
a circuit for supplying output data;
a data output line connected to an output of the circuit for supplying output data; and
an AND gate having a first input connected to the control line, a second input connected to the data output line, and an output connected to an input of a buffer; and
a port implemented in the semiconductor device for connecting to an in-circuit emulator, wherein a line on the port is also connected to an output of the buffer,
wherein when the in-circuit emulator requests access to the secure area, the microprocessor core generates microprocessor signals for decoding by the decoder, and
wherein the decoder decodes the microprocessor signals and generates a control signal on the control line connected to the first input of the AND gate, and
wherein the AND gate outputs an obstructing signal to obstruct access by the in-circuit emulator to the secure area.
